(19) United States
(12) Patent Application Publication
(10) Pub. No.: US 2019/0190128 A1
(43) Pub. Date: Jun. 20, 2019

(54) SYSTEMS, DEVICES, AND METHODS FOR A WEARABLE RING ANTENNA

(71) Applicant: NORTH INC., Kitchener (CA)

(72) Inventor: George Shaker, Waterloo (CA)

(21) Appl. No.: 16/227,347

(22) Filed: Dec. 20, 2018

Related U.S. Application Data
(60) Provisional application No. 62/608,463, filed on Dec. 20, 2017.

(51) Int. Cl. H01Q 1/27; H01Q 1/36; H01Q 9/16; A44C 9/00; A44C 9/02

(52) U.S. Cl. CPC H01Q 1/273; H01Q 1/362; A44C 9/02; A44C 9/0053; H01Q 9/16

(57) ABSTRACT

Systems, devices, and methods for a wearable ring antenna are disclosed. The wearable ring antenna includes a ring body member having a circumference for placing around a user's finger, and an electronic circuit housed within the ring body member. The ring body member has a first end portion and a second end portion defining a break in the circumference for accommodating a plurality of finger sizes. The electronic circuit includes: a harvester unit capable of harvesting energy; a sensor unit for detecting hand gestures made by the user and generating signals based on the gestures; an electrical energy storage component capable of storing energy harvested by the harvester unit and providing power to the electronic circuit; and a communication interface for transmitting and receiving signals via a communication network. The ring body member provides a radio frequency (RF) antenna for the signals transmitted and received via the communication network.

### TECHNICAL FIELD

The present systems, devices, and methods generally relate to wearable electronic devices and particularly relate to a wearable ring antenna.

### BACKGROUND

### Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be “wireless” (i.e., designed to operate without any wire-connections to other, non-portable electronic systems); however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

Because they are worn on the body of the user, visible to others, and generally present for long periods of time, form factor (i.e., size, geometry, and appearance) is a major design consideration in wearable electronic devices.

### BRIEF SUMMARY

The various embodiments described herein generally relate to wearable ring antenna (and associated methods to provide and systems configured to implement the wearable ring antenna). The wearable ring antenna includes a ring body member having a circumference for placing around a user's finger and an electronic circuit housed within the ring body member. The ring body member has a first end portion and a second end portion defining a break in the circumference for accommodating a plurality of finger sizes. The electronic circuit includes a harvester unit capable of harvesting energy; a sensor unit for detecting hand gestures made by the user and generating signals based on the gestures; an electrical energy storage component capable of storing energy harvested by the harvester unit and providing power to the electronic circuit; and a communication interface for transmitting and receiving signals via a communication network. The ring body member provides a radio frequency (RF) antenna for the signals transmitted and received via the communication network.

In some embodiments, the electronic circuit is formed on a flexible printed circuit board.

In some embodiments, the wearable ring antenna further includes a reinforcement member for increasing stiffness of the wearable ring antenna.

In some embodiments, the electrical energy storage component comprises at least one of a capacitor and a battery.

In some embodiments, the electronic circuit further includes an AC-DC conversion regulation circuit.

In some embodiments, the harvester unit includes a piezoelectric harvester unit.

In some embodiments, the RF antenna includes a dipole antenna.

In some embodiments, the RF antenna includes a matched dipole antenna.

In some embodiments, the RF antenna includes a tee matched (T-matched) dipole antenna.

In some embodiments, the signals transmitted and received by the communication interface have a frequency between about 2400 Megahertz (MHz) to about 2500 MHz.

In some embodiments, the signals transmitted and received by the communication interface have a frequency of about 2460 MHz.

In some embodiments, the signals transmitted and received by the communication interface have a frequency of at least one of 100 MHz, 200 MHz, 300 MHz, 400 MHz, 800 MHz, and 900 MHz.

In some embodiments, the ring body member is formed of a conductive material.

In some embodiments, the wearable ring antenna further includes an insert member housed within the ring body member, the ring body member is formed of a non-conductive material, and the insert member is formed of a conductive material.

In some embodiments, the break is radial such that each of the first end portion and the second end portion are flat in a direction parallel to a longitudinal axis of the ring body member.

In some embodiments, the break is disjointed in a longitudinal direction of the ring body member such that each of the first end and the second end are L-shaped.

In some embodiments, the ring body member includes either a circular band shape, a helical shape, or a spiral shape.

In some embodiments, when the ring body member includes a helical shape or a spiral shape, the ring body member includes less than two turns.

In some embodiments, the wearable ring antenna further includes a filler member positioned within the break and connecting the first end portion and the second end portion.

In some embodiments, the filler member is formed of a dielectric material.

In some embodiments, the ring body member is coated.

In some embodiments, the coating is paint.

In some embodiments, the wearable ring antenna further includes a button for receiving user input.

In some embodiments, the button is at least one of a push button and a touch button.

In another broad aspect, a method of providing a wearable electronic device includes providing an electronic circuit and housing the electronic circuit within a ring body member. The electronic circuit includes a harvester unit capable of harvesting energy; a sensor unit for detecting hand gestures made by the user and generating signals based on the gestures; an electrical energy storage component capable of storing energy harvested by the harvester unit and providing power to the electronic circuit; and a communication interface for transmitting and receiving signals via a communication network. The ring body member has a circumference for placing around a user's finger. The ring body member has a first end portion and a second end portion defining a break in the circumference for accommodating a plurality of finger sizes. The ring body member is capable of providing a radio frequency (RF) antenna for the signals transmitted and received via the communication network.

In another broad aspect, a system implementing a wearable ring antenna includes a computing device and the wearable ring antenna. The wearable ring antenna is capable of communicating with the computing device via a communication network.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a perspective view of a ring body member of an apparatus, according to the present systems, devices, and methods;

FIG. 2 is a perspective view of an electronic circuit that can be housed within the ring body member shown in FIG. 1, according the present systems, devices, and methods;

FIG. 3 is a block diagram representation of the electronic circuit shown in FIG. 2;

FIG. 4 is an enlarged view of a grounded antenna arm shown in FIG. 2;

FIG. 5 is an enlarged view of a connection of the grounded antenna arm shown in FIGS. 2 and 4;

FIG. 6 is an enlarged view of a portion of the electronic circuit shown in FIG. 2;

FIG. 7 is a perspective view of a ring body member of an apparatus, according to the present systems, devices, and methods;

FIG. 8 is another view of the ring body member shown in FIG. 7, according to the present systems, devices, and methods;

FIG. 9 is another view of the ring body member shown in FIG. 7, according to the present systems, devices, and methods;

FIG. 10 is a block diagram representation of the electronic circuit that can be housed within the ring body member shown in FIG. 7, according to the present systems, devices, and methods;

FIG. 11 is a side cutaway view of an apparatus, according to the present systems, devices, and methods;

FIG. 12 is a side cutaway view of an apparatus, according to the present systems, devices, and methods;

FIGS. 13, 14, 15, 16, 17, and 18 are bottom, side, perspective, side cutaway, perspective cutaway, and top views of an apparatus, according to the present systems, devices, and methods;

FIGS. 19, 20 and 21 are perspective and side views of an apparatus, according to the present systems, devices, and methods; and

FIG. 22 is a flow-diagram of a method for providing an apparatus, according to the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

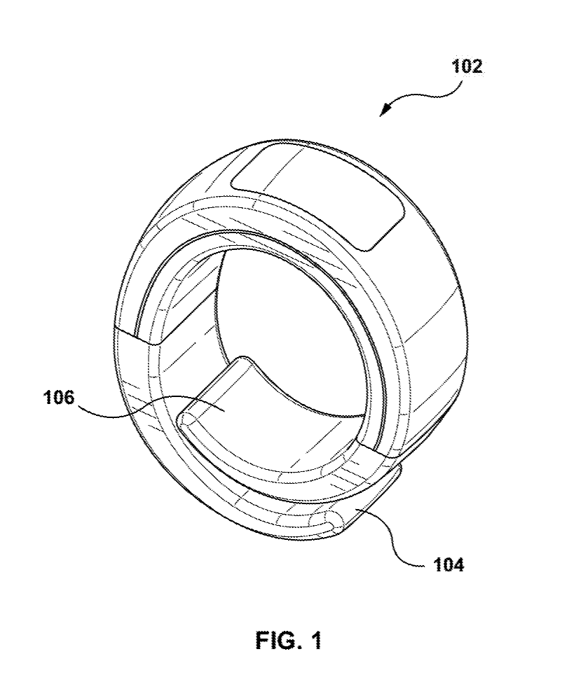

Referring to FIG. 1, shown therein is a perspective view of a ring body member 102 of an apparatus, according to the present systems, devices, and methods. The ring body member 102 can be worn around a user's finger. The shape of the ring body member 102 is shown for illustrative purposes and is not limited to the illustrated shape. Other shapes can be used. For example, the ring body member 102 can have a general shape of a circular band, a helix, or a spiral. The ring body member 102 can have any appropriate shape that allows the ring body member to remain positioned around the user's finger.

A ring body member 102 having a spiral shape is shown in FIG. 1. The ring body member 102 has a first end 104 and a second end 106. The spiral shape has a radius that is non-constant. The spiral shape shown in FIG. 1 has more than one turn. The non-constant radius allows a portion of the first end 104 to overlay a portion of the second end 106.

In another implementation, the ring body member can have a helical shape. Like the spiral shape, a helical shaped ring body member can have a first end and a second end. In contrast to the spiral shape, the height of the helical shape rises with each turn (i.e., pitch of the helix). Depending on the pitch, a portion of the first end may not overlay a portion of the second end when the helical shape has more than one turn.

In another implementation, the ring body member can have a circular band shape, at least with respect to an internal surface of the ring body member.

With a circular band shape, the inner radius of the ring body member is generally constant.

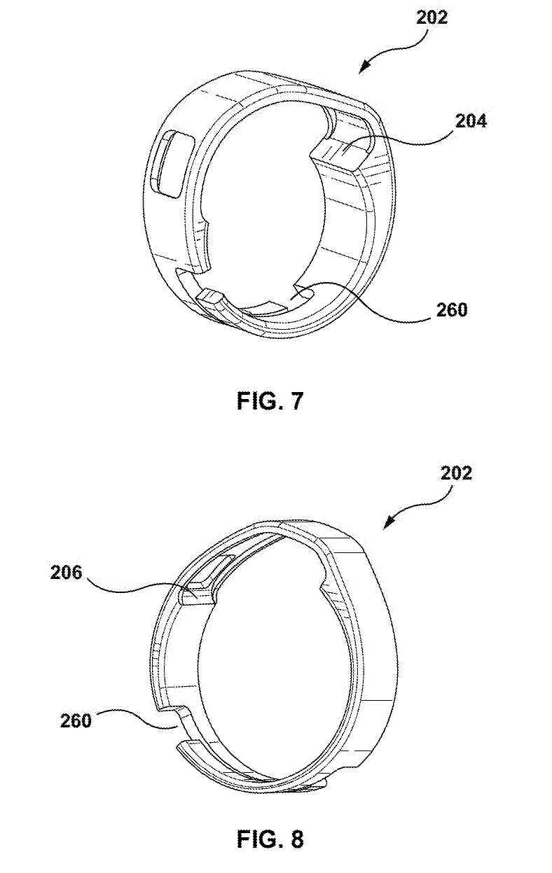

In some implementations, the ring body member can have at least one break. The break can allow the ring body member to expand and/or can be used to electrically separate/insulate electrical pathways such as antenna components. When the ring body member can expand, it can accommodate or tolerate fingers having different ring sizes. Breaks are described in more detail below in reference to FIG. 7.

The ring body member 102 can be formed of a conductive material. For example, the conductive material can be, but is not limited to, a metal such as aluminum, steel, or copper, or any combination thereof.

In some implementations, the ring body member 102 can be formed of a non-conductive material. The ring body member 102 can include an insert. When the ring body member 102 is formed of a non-conductive material, the insert can be conductive and/or metallic.

The ring body member 102 can be coated. For example, the ring body member 102 can be coated with paint. In another example, the ring body member 102 can be coated with a conductive material.

The ring body member 102 can include a filler member positioned within the break and connecting the first end portion and the second end portion. The filler member can be formed of a dielectric material.

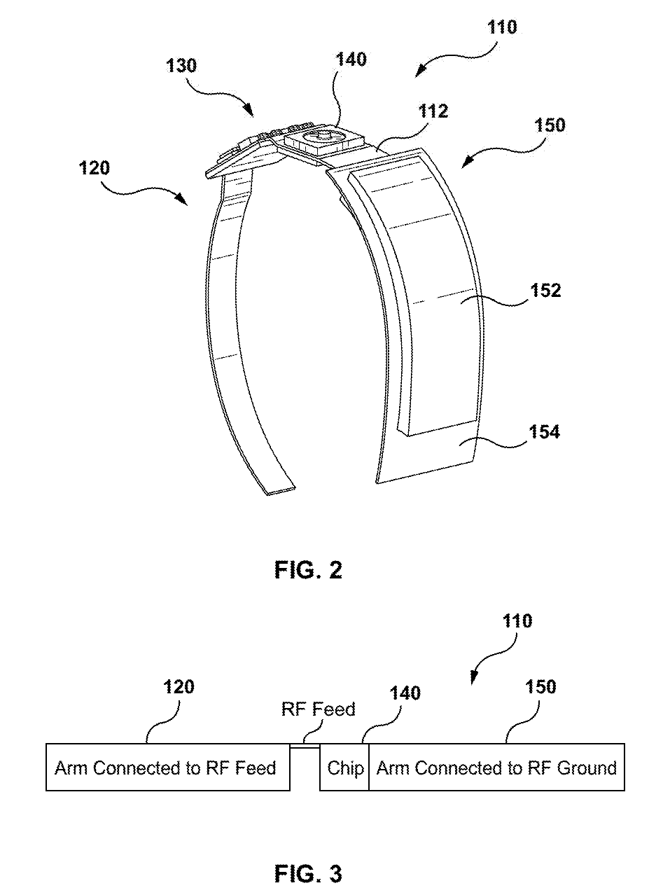

Referring to FIGS. 2 and 3, shown therein is a perspective view and a block diagram representation of an electronic circuit 110 housed within the ring body member 102 shown in FIG. 1, according to the present systems, devices, and methods.

In some implementations, the electronic circuit 110 shown in FIGS. 2 and 3 can be mounted on a flexible printed circuit board (PCB) 112. In some implementations, some or all of the electronic circuit 110 can be mounted on a reinforcement member for increasing the stiffness of the apparatus. For example, the reinforcement member can be formed of a metallic material.

The electronic circuit 110 can include a communication interface 140, a first arm 120 and a second arm 150 of a radiofrequency antenna. When the communication interface 140 is located between the first arm 120 and the second arm 150, causing a disconnect between the first arm 120 and the second arm 150, the electronic circuit 110 can form a dipole antenna. The first arm 120 is connected to an RF feed 130. The second arm 150 includes a ground patch 152 mounted on a ground plane surface 154. That is, the second arm 150 is connected to ground.

The communication interface 140 can facilitate communication via a communication network. The communication interface 140 can be a Bluetooth® Low Energy chip having a signal frequency of about 2400 MHz to about 2500 MHz, or similar. In some implementations, the communication interface 140 can operate with signals having a frequency in a band of about 100 MHz, 200 MHz, 300 MHz, 400 MHz, 800 MHz, and/or 900 MHz.

The electronic circuit 110 can also include additional electronic components which can be collectively referred to as 130, such as a harvester unit 132 capable of harvesting energy (shown in FIG. 6), a sensor unit 134 for detecting inputs from the user and generating signals based on the inputs (shown in FIG. 6); and an electrical energy storage 136 component capable of storing energy harvested by the harvester unit and providing power to the electronic circuit (shown in FIG. 6).

The harvester unit can be a piezoelectric harvester unit. In some implementations, the harvester unit can harvest energy from direct impact. In some implementations, the harvester unit can harvest energy from vibrations. In some implementations, the harvester unit can be an electrodynamic harvester unit. The additional electronic components 130 can also include an AC-DC converter (not shown). The additional electronic components 130 are shown for illustrative purposes and are not limited to the illustrated shape, sizes, or positions shown.

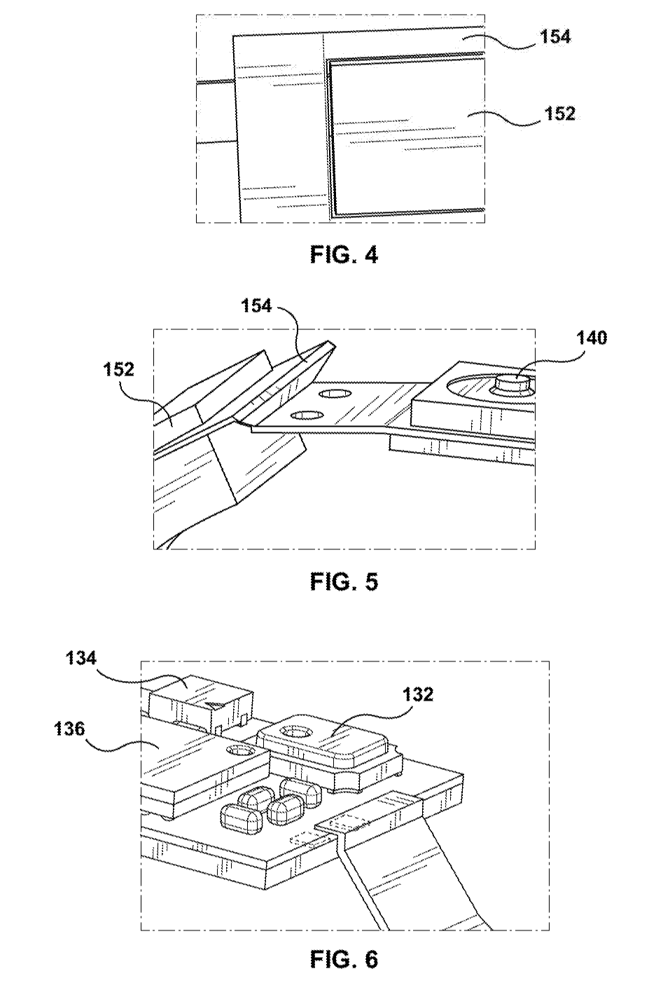

Referring to FIG. 4, shown therein is an enlarged view of a grounded antenna arm 150 shown in FIG. 2. As shown in FIG. 4, a gap can be provided between the ground plane surface 154 and the ground patch 152. However, the gap is not critical. That is, the ground plane surface 154 can be fully closed to accommodate an electrical energy storage component 136 on a side of the ground plane surface 154. The electrical energy storage component 136 can be a capacitor and/or a battery.

Referring to FIG. 5, shown therein is an enlarged view of a connection of the second arm 150 shown in FIGS. 2 and 4. As shown in FIG. 5, ground plane continuity should be provided. The ground plane surface 154 can be connected using any appropriate shape and is not limited to the shape shown in FIG. 5.

Referring to FIG. 6, shown therein is an enlarged view of a portion of the electronic circuit 110 shown in FIG. 2. As shown in FIG. 6, components can be soldered on the PCB.

In at least one implementation, the wearable ring antenna can experience a gain on the finger by approximately −4 dB.

Referring to FIGS. 7 and 8, shown therein are perspective views of a ring body member 202 of an apparatus, according to the present systems, devices, and methods.

The ring body member 202 shown in FIGS. 7 and 8 has a circular band shape. Furthermore, the ring body member 202 includes a break 260 that is disjointed along the longitudinal axis. While the following description of a break is described in relation to a ring body member having a circular band shape, breaks can also be provided in ring body members having a spiral or helical shape. Each break can define a first end of the ring body member and a second end of the ring body member.

The break 260 in ring body member 202 is disjointed along the longitudinal axis, which causes the first and second ends to have L-shapes and be spaced apart.

In some implementations, the break 260 can be linear, in a direction parallel to the longitudinal axis of the circular band. Accordingly, each of the first end and the second end can be flat.

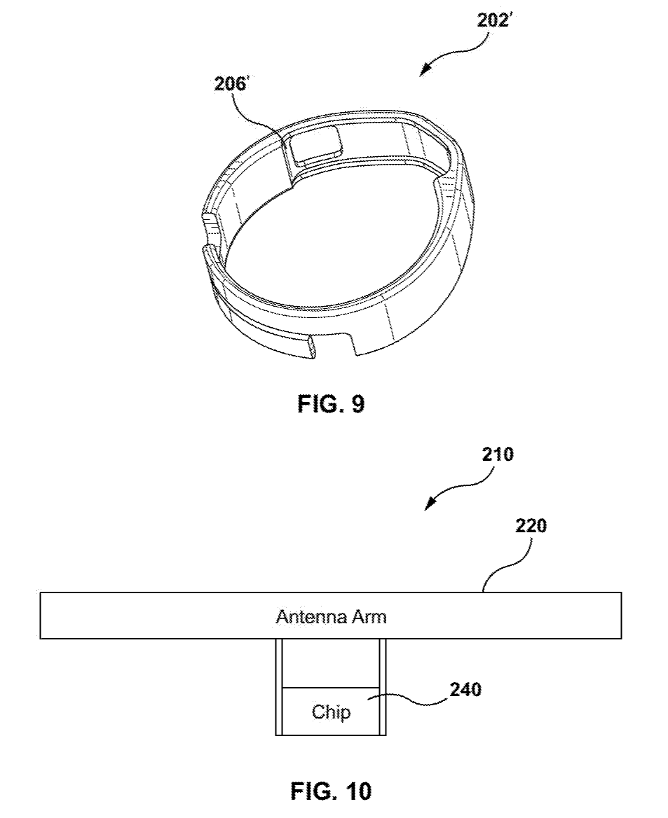

The ring body member 202 can have two connection points: a ground connection point 204 and signal connection point 206, according to some implementations. In other implementations, the signal connection point 204′ can be located at a different point along the circumference of the ring body member 202′ (show in FIG. 9).

Referring to FIG. 10, shown therein is a block diagram representation of electronic components provided within the ring body member shown in FIG. 7, according to the present systems, devices, and methods. The electronic circuit 210 can include a communication interface 240 and a radiofrequency antenna 220. In this implementation, the communication interface 240 does not create a disconnect along the antenna 220. Accordingly, the electronic circuit 220 can form a tee matched dipole antenna.

Since the antenna will be worn by a user, it will be in close proximity to the user's body. By being in close proximity to the user's body, the user's body can affect the input impedance of the antenna. The length of the antenna can be designed to minimize the input impedance. In particular, the length of the antenna can be designed to consider impedance matching. Generally, an ideal length of the antenna is nλ/2, wherein λ is the wavelength of a signal guided.

In addition to selecting an appropriate length for the antenna, matching may also be provided by an impedance matching module on the PCB.

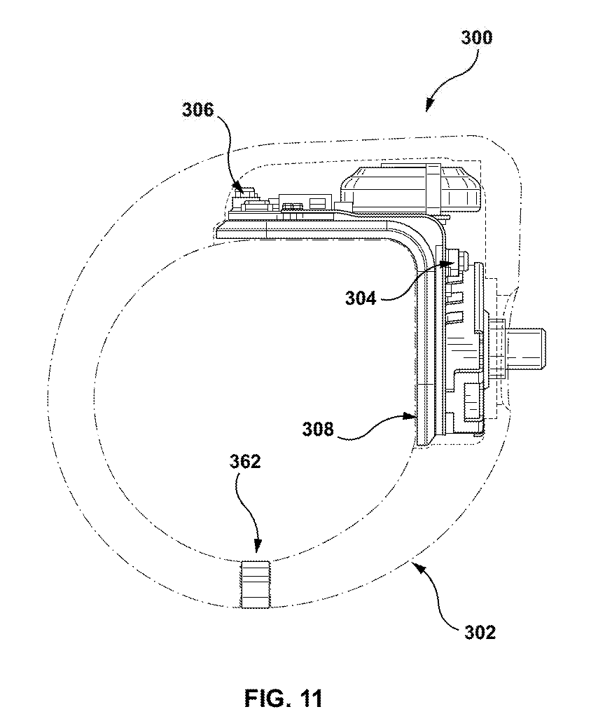

Referring to FIG. 11, shown therein is a side cutaway view of an apparatus 300, according to another implementation of the present systems, devices, and methods. As shown in FIG. 11, the ring body member 302 can have two connection points: a ground connection point 304 and an RF feed connection, that is a signal connection point 306, according to some implementations. The ring body member 302 may be a singular conductive piece of material, such as a metal. The ring body member 302 can include a break 360 (not shown). The apparatus 300 can include a filler member 362 positioned within the break and connecting the first end portion and the second end portion. The filler member can be formed of a dielectric material. The apparatus 300 can include a non-conductive member 308. The non-conductive member can be formed of plastic.

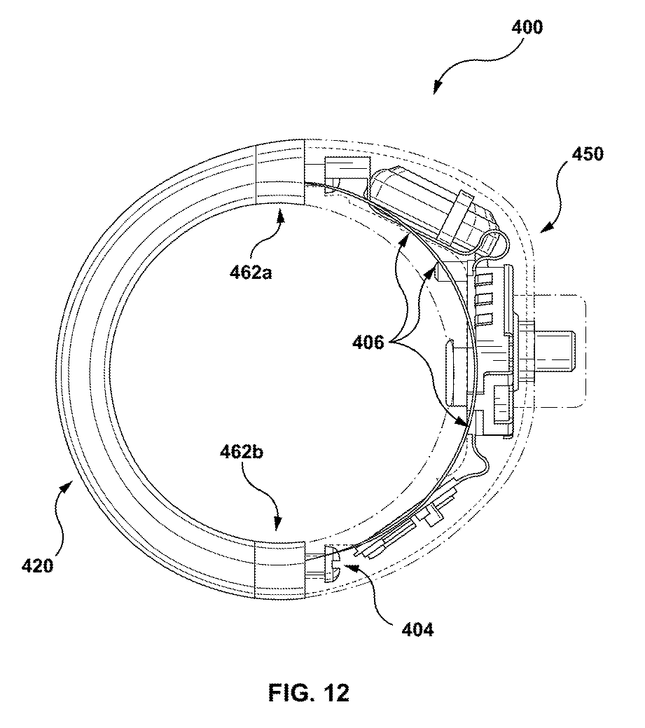

Referring to FIG. 12, shown therein is a side cutaway view of an apparatus 400, according to another implementation. The apparatus 400 has two breaks, each of which is filled with a filler member 462a and 462b in the ring body member. With two breaks, the antenna arm of the apparatus 400 is discontinuous. That is, the antenna is a dipole antenna with a first arm 420 connected to the RF feed and a second arm 450 connected to ground. The apparatus 400 has a plurality of connection points: ground connections 404 and an RF feed connection 406.

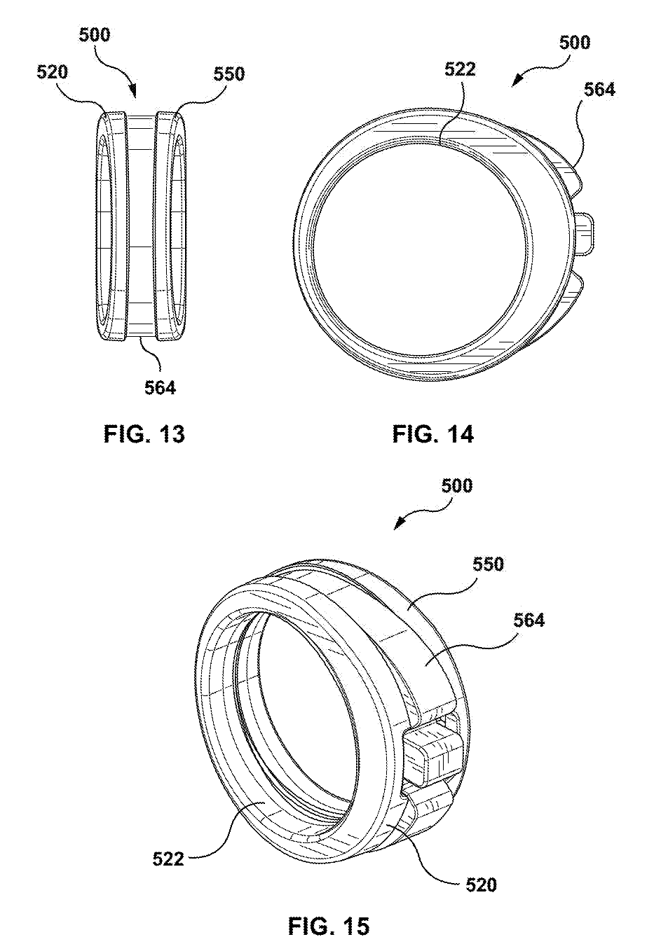

Referring to FIGS. 13, 14, 15, 16, 17, and 18, shown therein are bottom, side, perspective, side cutaway, perspective cutaway, and top views of an apparatus 500, according to the present systems, devices, and methods.

The inner diameter 522 and two side rings 520 and 550 can each be formed of a conductive material. The middle ring 564 can be formed of a non-conductive material. Each of the side rings serve as an arm of a dipole antenna. That is, the first side arm 520 is the RF feed and the second side arm 550 is the ground feed. The separation between the side rings may be minimized in order to improve the aesthetics of the apparatus 500. However, separation must be maintained in order for the arms to operate as a dipole antenna.

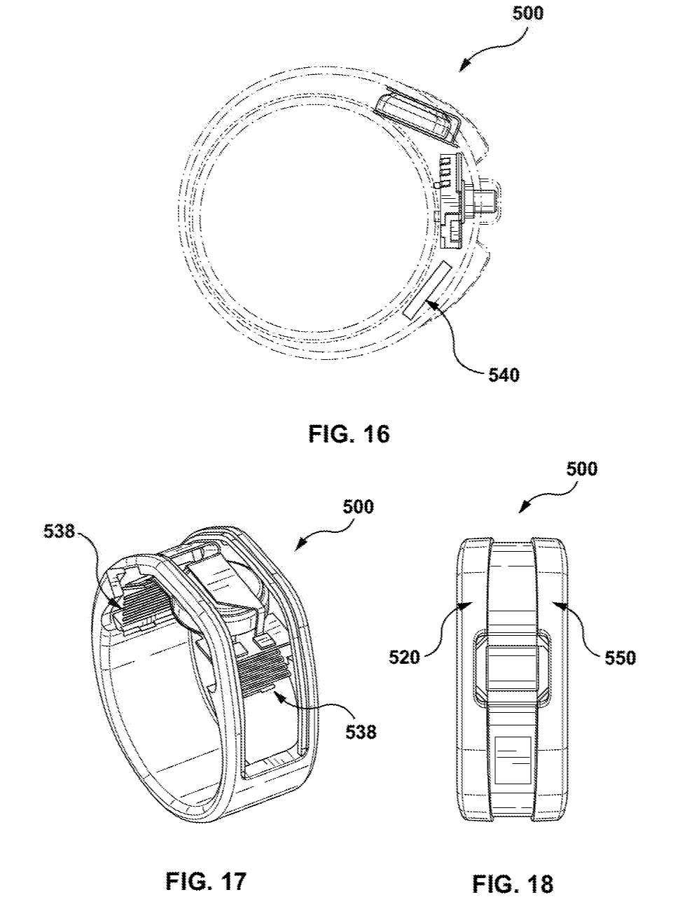

As shown in FIGS. 16 and 17, the apparatus 500 includes a communication interface unit 540 and flex antennas 538. The length and the position of the flex antenna within the metal ring can be selected to provide impedance matching.

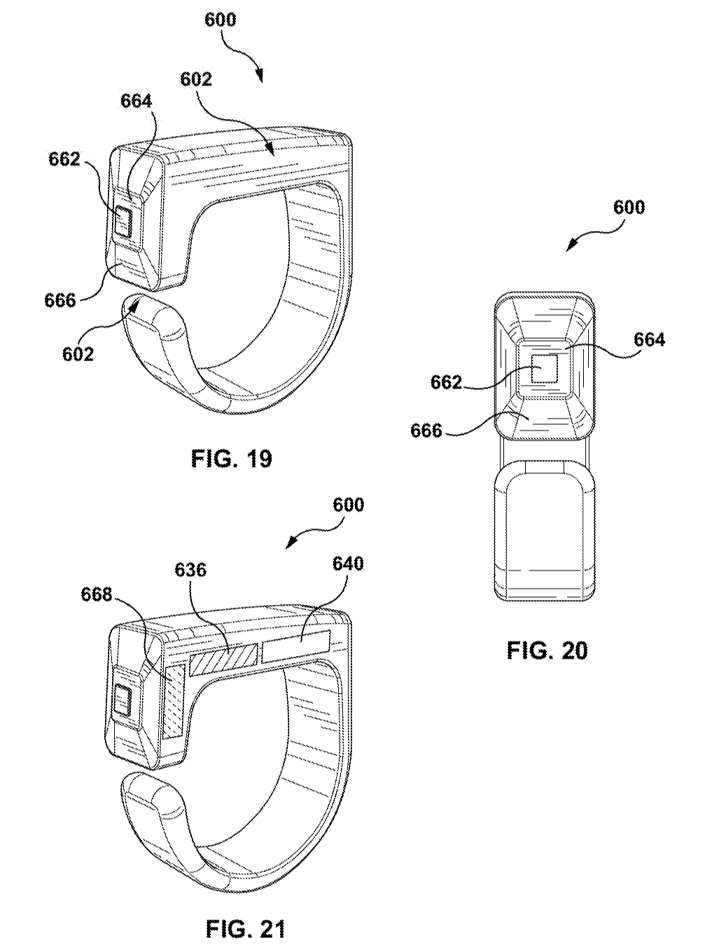

Referring to FIGS. 19, 20 and 21, shown therein are perspective and side views of an apparatus 600, according to the present systems, devices, and methods. Similar to apparatus 200, apparatus 600 can provide a tee matched dipole antenna.

The apparatus 600 includes a ring body member 602. The ring body member 602 can be formed of a conductive material. As can be seen in FIG. 19, the ring body member 602 can have a generally circular band shape. The ring body member 602 can have a break 660. The break 660 can be filled with non-conductive material (not shown). As shown, the break 660 is linear, in a direction parallel to the longitudinal axis of the circular band. Accordingly, each of the first end portion and the second end portion are flat. More specifically, the edges adjacent to the break 660 are flat.

The ring body member 602 can include a cover 666. The cover 666 can hold a key cap 662 and a seal 664. The key cap 662 can be formed of a conductive material. The seal 664 can be waterproof. The seal 664 can be formed of a silicone material.

The apparatus includes a communication interface unit 640, an electrical energy storage component 636 and an input device (e.g., a joystick) 668.

As can be seen, the ring body member can include additional shapes such as a square top.

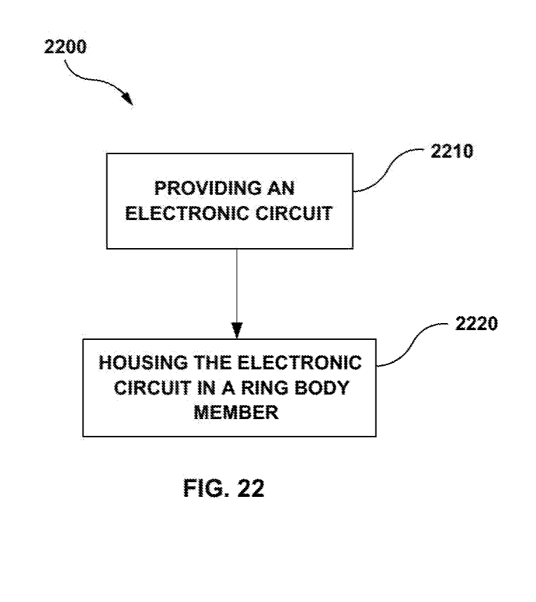

FIG. 22 is a flow-diagram showing a method 2200 of providing a wearable electronic device in accordance with the present systems, devices, and methods. The wearable electronic device may be substantially similar to any or all of the implementations illustrated in FIGS. 1 through 21. Method 2200 includes two acts 2210 and 2220 though those of skill in the art will appreciate that in alternative implementations certain acts may be omitted and/or additional acts may be added. Those of skill in the art will also appreciate that the illustrated order of the acts is shown for exemplary purposes only and may change in alternative embodiments.

At 2210, an electronic circuit can be provided. The electronic circuit can include a harvester unit capable of harvesting energy; a sensor unit for detecting inputs (e.g., tactile inputs; actuations of an actuator, button, or joystick; or hand gestures detected by an inertial measurement unit) made by the user and generating signals based on the inputs; an electrical energy storage component capable of storing energy harvested by the harvester unit and providing power to the electronic circuit; and a communication interface for transmitting and receiving signals via a communication network.

At 2220, the electronic circuit can be housed within a ring body member. The ring body member can have a circumference for placing around a user's finger. The ring body member can have a first end portion and a second end portion defining a break in the circumference for accommodating a plurality of finger sizes and/or for providing desired rf antenna functionality. The ring body member can provide a radio frequency (RF) antenna for the signals transmitted and received via the communication network.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like.

Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable ring antenna comprising:
a ring body member having a circumference for placing around a user's finger, the ring body member having a first end portion and a second end portion defining a break in the circumference;
an electronic circuit housed within the ring body member, the electronic circuit comprising:
a sensor unit to detect inputs made by the user and generate signals based on the inputs;
an electrical energy storage component to store energy and provide power to the electronic circuit; and
a communication interface to transmit signals via a communication network;
wherein the ring body member provides a radio frequency (RF) antenna for the signals transmitted via the communication network.

2. The wearable ring antenna of claim 1 wherein the electronic circuit is formed on a flexible printed circuit board.

3. The wearable ring antenna of claim 1, further comprising a reinforcement member to increase a stiffness of the wearable ring antenna.

4. The wearable ring antenna of claim 1 wherein the electrical energy storage component comprises at least one component selected from a group consisting of: a capacitor and a battery.

5. The wearable ring antenna of claim 1, further comprising a piezoelectric harvester unit to harvest energy, the piezoelectric harvester unit communicatively coupled to the electrical energy storage component.

6. The wearable ring antenna of claim 1 wherein the RF antenna comprises a dipole antenna.

7. The wearable ring antenna of claim 6 wherein the RF antenna comprises a matched dipole antenna.

8. The wearable ring antenna of claim 7 wherein the RF antenna comprises a tee matched (T-matched) dipole antenna.

9. The wearable ring antenna of claim 1 wherein the signals transmitted by the communication interface have a frequency between 2400 Megahertz (MHz) and 2500 MHz.

10. The wearable ring antenna of claim 1 wherein the signals transmitted by the communication interface have at least one frequency selected from a group consisting of: 100 MHz, 200 MHz, 300 MHz, 400 MHz, 800 MHz, and 900 MHz.

11. The wearable ring antenna of claim 1 wherein the ring body member is formed of a conductive material.

12. The wearable ring antenna of claim 1, further comprising an insert member housed within the ring body member, the ring body member being formed of a non-conductive material, and the insert member being formed of a conductive material.

13. The wearable ring antenna of claim 1 wherein the break is radial and each of the first end portion and the second end portion are flat in a direction parallel to a longitudinal axis of the ring body member.

14. The wearable ring antenna of claim 1 wherein the break is disjointed in a longitudinal direction of the ring body member and each of the first end and the second end are L-shaped.

15. The wearable ring antenna of claim 1 wherein the ring body member comprises either a circular band shape, a helical shape, or a spiral shape.

16. The wearable ring antenna of claim 1, further comprising a filler member positioned within the break and physically connecting the first end portion and the second end portion.

17. The wearable ring antenna of claim 16 wherein the filler member is formed of a dielectric material.

18. The wearable ring antenna of claim 1 wherein the sensor unit includes a button to receive user input.

19. A method of providing a wearable electronic device comprising:
providing an electronic circuit comprising:
a sensor unit to detect inputs made by the user and generate signals based on the inputs;
an electrical energy storage component to store energy and provide power to the electronic circuit; and
a communication interface to transmit signals via a communication network; and
housing the electronic circuit within a ring body member, the ring body member having a circumference for placing around a user's finger, the ring body member having a first end portion and a second end portion defining a break in the circumference, the ring body member capable of providing a radio frequency (RF) antenna for the signals transmitted via the communication network.

20. A system comprising:
a computing device; and
a wearable ring antenna to communicate with the computing device via a communication network, the wearable ring antenna comprising:
a ring body member having a circumference for placing around a user's finger, the ring body member having a first end portion and a second end portion defining a break in the circumference;
an electronic circuit housed within the ring body member, the electronic circuit comprising:
a sensor unit to detect inputs made by the user and generate signals based on the inputs;
an electrical energy storage component to store energy and provide power to the electronic circuit; and
a communication interface to transmit signals via the communication network;
wherein the ring body member provides a radio frequency (RF) antenna for the signals transmitted via the communication network.
